(19) United States
(12) Patent Application Publication
(10) Pub. No.: US 2007/0276538 A1
(43) Pub. Date: Nov. 29, 2007

(54) Tool for an Industrial Robot

(75) Inventors: Jimmy Kjellsson, Vasteras (SE); Gisle Bryne, Tokyo (JP); Guntram Scheible, Hirschberg (DE); Jan-Erik Frey, Vasteras (SE); Martin Strand, Vasteras (SE); Tobias Gentzell, Vasteras (SE)

Correspondence Address: VENABLE LLP, P.O. BOX 34385, WASHINGTON, DC, 20043-9998, US

(73) Assignee: ABB Research LTD., Zurich (CH)

(21) Appl. No.: 10/583,387

(22) PCT Filed: Apr. 6, 2004
(86) PCT No.: PCT/SE04/00553

§ 371 Date: May 7, 2007

(30) Foreign Application Priority Data
Dec. 17, 2003 (SE) 030445-1

(51) Int. Cl. G05B 19/418; B25J 9/02; G06F 9/00; H02J 17/00

(52) U.S. Cl. 700/245; 318/568.11; 318/568.2; 318/825; 901/14; 901/19

(57) ABSTRACT

A robot or manipulator including a wireless power supply and a wireless communication device. One or more actuators on the robot tool may be wirelessly powered and wirelessly controlled. The robot tool may have one or more wireless communication members for transmission of data from sensors on the tool. The power supply includes a primary power supply member and secondary power supply member. Tool changes may be carried out automatically by the robot. In other aspects of the invention a method, a control system and a computer program for carrying out the method are described.

### TECHNICAL FIELD

The present invention concerns a tool for an industrial robot and use of the industrial robot with the tool. The invention relates to a tool for robotic and highly automated production applications comprising a contactless power supply and arranged with wireless communication to the tool.

### BACKGROUND ART

Many different types of tools exist for use in operations carried out by robots. Common among robot tools are grippers, clamps, jaws, and more specialised tools such as paint spray guns and welding guns. Such tools may be mounted on the last axis of the manipulator or robot (eg in/on the wrist of a robot arm). Ideally, the tool should have an unlimited degree of freedom, including that it may rotate without limitations. Many tools are simple and require only a compressed air supply, for example. Others may have more complicated functions and require process media, such as compressed air, cooling media, electric power as well as control signaling between the robot control unit and the tool. Normally all these media, power and control wiring are collected in one process cabling which may be bundled in a flexible tube. Such a tube may be arranged on the outside of the robot and on the outside of the robot arm holding the tool. Alternatively the tube may be arranged, at least in part, inside the robot arm. Costly, highly flexible wires are used. However, whether arranged outside or inside a robot arm, the fact is that due to complex twisting and repeated bending of the cabling the individual cable parts of the cabling wear out frequently or begin to fail in one way or another. Often the whole cabling has to be replaced.

Another technique for transferring power and/or communications includes the use of electromechanical slip-rings, normally requiring a plurality of slip-rings to supply signals and power with high precision, and expensive precious materials in order to achieve a service lifetimes of perhaps 1-2 years maximum.

An important criteria in robotic and highly automated production applications, in automobile manufacturing for example, is a separate power supply line which is provided for actuators. However, if wireless or contactless supplies are used for power supply then the robot application may require two parallel supply arrangements to realize general and safe actuator power supply, which is made difficult and costly due to the restricted space available, for example, on a robot wrist, as well as restrictions to do with electromagnetic interference.

Robots are used extensively and successfully for repeated operations. However robots are complex, expensive and it is very time-consuming to program them for new operations. For these and other reasons it is desirable in some applications for the same robot to be able to use more than one tool. However, tool changes are time-consuming, cause production delays and may introduce undesirable variation into task cycles causing for example, variable heating or cooling effects.

### SUMMARY OF THE INVENTION

A primary aim of the present invention is to provide a tool for an industrial robot with a wireless power supply and wireless communication that overcomes the drawbacks of known such robot tools. A secondary aim is to provide a tool for an industrial robot that may be changed or exchanged automatically.

The above and more objects are achieved according to the invention by a tool for an industrial robot according independent claim 1 by a method according to independent claim 13 and a system according to independent claim 22. Preferred embodiments are described in the dependent claims.

According to a first aspect of the invention these and more aims are met by the invention in the form of robot tool equipped with a contactless power supply for at least one actuator of the tool and a wireless communication system for automation or robotic automation of the tool.

In a preferred embodiment the power supply for the robotic automation device is a wireless or contactless power supply system using e.g. magnetic or electric coupling through the air. In an advantageous further preferred embodiment it additionally contains power supply logic circuits on the sending and receiving unit, by which communications may be carried over the power supply in a secure way: either by interpreting, preferably using a digital method, a certain blank period as, for example, a stop signal or by using an advanced communication pattern to detect a signal such as a re-start signal.

In a preferred embodiment of the invention the control unit(s) comprise one or more microprocessor units or computers. The control unit(s) comprises memory means for storing one or more computer programs that control the power transfer. Preferably a such computer program contains instructions for the processor to perform the method as mentioned and described later. In one embodiment the computer program is provided on a computer readable carrier such as a CD ROM. In another embodiment of the invention the program is provided at least in parts over a network such as the Internet. For receiving data or computer program code the computer unit has a communication link with a local area network. This link may comprise a wireless system, a direct contact conduction system or as an overlay on the power supply.

The principal advantage of the invention is that the compact nature of the preferred embodiment with a contactless power supply and wireless communication to the tool means that a tool may be fixed to or changed on the robot or more quickly and simply. No communication connections or electrical power cables need to be disconnected or re-connected in order to change from one tool to another. There are no electrical cables running between the robot and tool to be damaged or get in the way of a tool change, especially an automatic tool change carried out by the robot. The robot simply moves the present tool to a storage position (a rack or holder or the like), releases the present tool by, for example, activating an actuator, then moves the robot arm and the tool holder on the arm to the correct position to engage a second tool at a second position, and engages the second tool, by for example, activating a locking device to fasten the tool to the tool holder. Automatic tool changes from one tool to another may be carried out swiftly and accurately. This also leads to the benefit that tool changes without physical human intervention becomes much more feasible, speeding up changes or reducing downtime and eliminating the need for a person to enter the production cell or other area around a robot. Another benefit is that automatic tool changes take place over a predictable and consistent period of time, thus reducing quality variation due to heating or cooling effects on materials used, eg adhesive, sealant, paint, or on the work object itself.

Another advantage is that by arranging the power transmitting part on the industrial robot and the receiving part on the tool the additional weight to the manipulator or robot arm is kept very small or is even less than the weight of a traditional system with cables or involving slip rings. Also the longitudinal extension of the tool interface is kept smaller than traditional solutions.

Another further advantage is that the compact size and low weight of the receiver and power supply components according to the invention reduces the wear and increases the service life for the robot or manipulator arm. In particular, wear and consequent replacement of wires, cable hoses etc running between the robot wrist and the tool is eliminated, and the invention thus reduces down time and service time. It is also an advantage that the tool according to the invention with wireless communication and contactless power may be used with any already installed robot, manipulator or similar automation device and as such may be applied to existing installations as well as new installations.

### BRIEF DESCRIPTION OF THE DRAWINGS

Embodiments of the invention will now be described, by way of example only, with particular reference to the accompanying drawings in which:

FIG. 1 is a schematic or block diagram for an industrial robot equipped with wireless control for an automation or robotic automation robot tool according to an embodiment of the invention;

FIG. 2 is a schematic diagram of an industrial robot equipped with cabled control for a tool according to the Prior Art;

FIG. 3 is a schematic for wireless communication and control for an automation or robotic automation robot tool between a robot controller and a robot tool according to an embodiment of the invention;

FIG. 4 is a schematic diagram showing more detail for the tool shown in FIG. 3 controlled by wireless communication;

FIG. 5 is a schematic block diagram of a method for controlling a robot with a tool according to an embodiment of the invention;

FIG. 6 is a schematic block diagram of a method for controlling a robot to change the tool according to an embodiment of the invention;

FIG. 7 is a schematic block diagram of a system comprising a robot arranged with a tool.

### DETAILED DESCRIPTION OF THE EMBODIMENTS

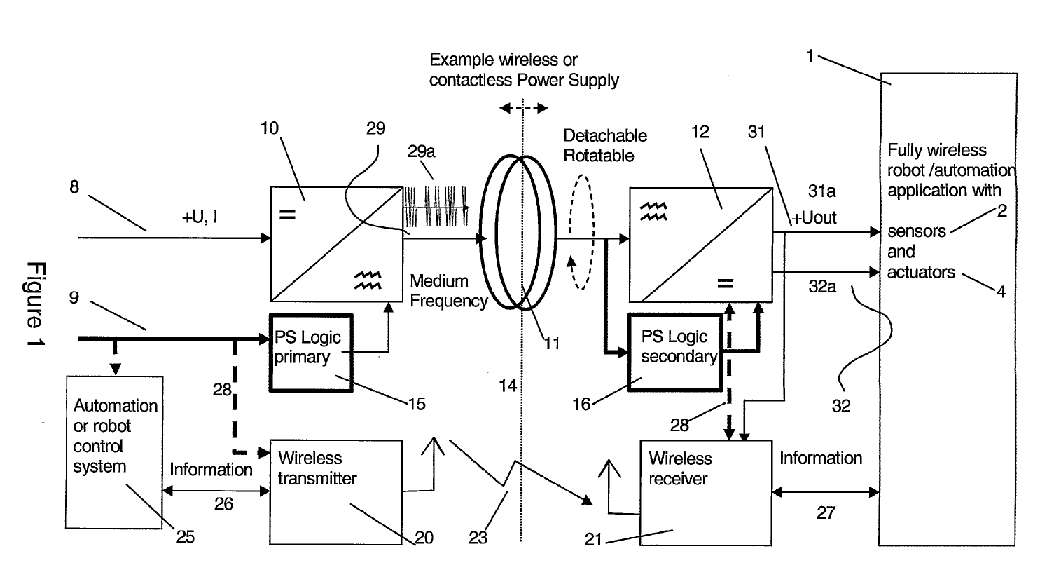

FIG. 1 shows a wireless communication system for automation or robotic automation in an embodiment of the invention in which the power supply is a wireless or contactless power supply system using e.g. magnetic or electric coupling through the air. As shown in the figure, the power supply may also be arranged with logic circuits on the sending unit and receiving unit, by which it can communicate over the power supply in a secure way. This is advantageous but the invention may also be practiced using a contactless power supply that does not include overlaid signals.

The power supply system 10 according to FIG. 1 comprises a primary part 10 and a secondary part 12. The primary part is attached to the industrial robot or other automation arrangement and the secondary part is attached to the tool. FIG. 1 shows an example of a tool or other robot application 1 that comprises one or more actuators 2 and sensors 4 (not shown in detail in FIG. 1). A contactless power supply 10 is shown on the left, primary, side of the diagram, which is preferably supplied with DC current 8. Alternatively an AC supply may be used. Power supply 10 is inductively coupled 11 with a receiving power supply 12 on the right side of the diagram, the secondary or tool side. A dotted line 14 is included to indicate schematically that, in this case, the tool or application 1 on the right side is detachable from the left side and fully rotatable. Each power supply 10, 12 may further comprise a logic function 15, 16 respectively. PS logic function communications 9 may be processed in the sending PS logic function 15 and overlaid in sending power supply 10 on a variable magnetic or electric field that induces a variable current in receiving power supply 16 on the tool side. As is symbolically represented in FIG. 1, a variable signal 29a that may be a high frequency signal may be imposed, overlaid or modulated in some way on the power output from 10, so that the power 29 received at the secondary side, at the tool side, may have a signal embodied in the received electrical power.

FIG. 1 also shows a wireless communication unit 20 arranged connected to a robot or automation control system 25, and the sending logic function 15. A corresponding wireless communication unit 21 arranged on the tool side connected to the logic function 16 at the receiving side. The diagram further illustrates that on the receiving side, a voltage Uout 31 is supplied to the robot application 1, and another voltage with 32 is supplied to actuators 2 comprised in the robot application 1. Voltage Uout 31 is supplied to robot application 1 components such as sensors 4 and intelligent devices (not shown). A control system 25, which may be a local robot control unit or a central control system, sends and receives control information 26 via the wireless communication unit 20 and a wireless link 23 to and from wireless communication unit 21 arranged on and connected to the tool side. Information from actuators 4, sensors 2, intelligent devices (not shown) of the robot application 1 is made available to wireless communication unit 21 for transmission to the robot control system 25.

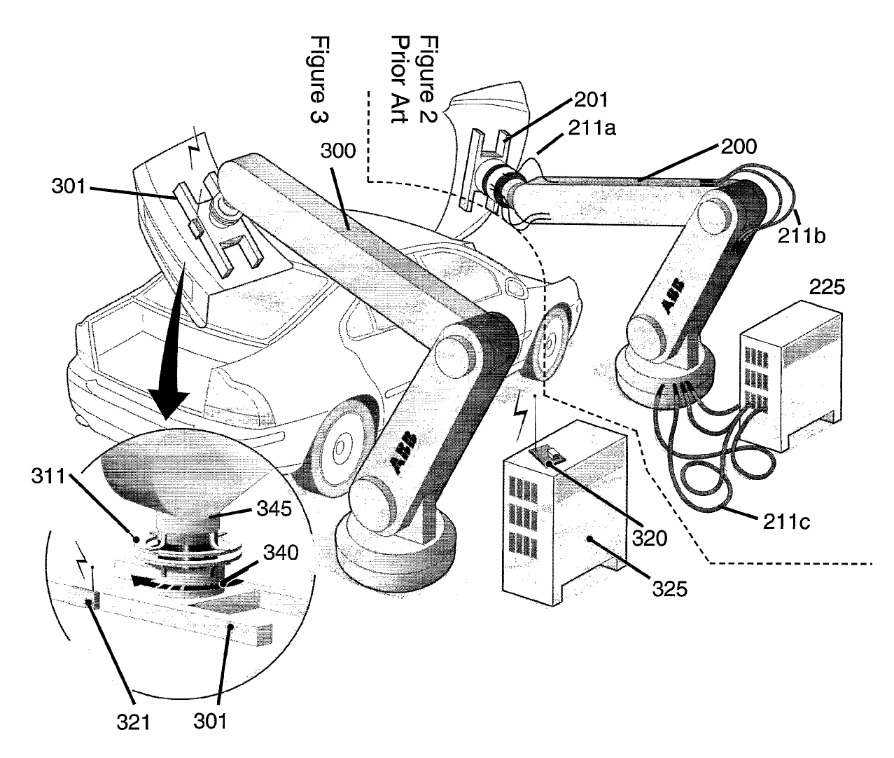

FIG. 2 shows an industrial robot 200 with a tool 201 controlled according to the Prior Art. Robot 200 is under control of a robot controller 225. Control cabling 211a for the robot tool 210 is shown arranged between tool 201 and the wrist or arm of the robot. Other control cables 211b, 211c also necessary under the prior art are shown. The robot is shown here fitting a part, a hood in this case, to an automobile.

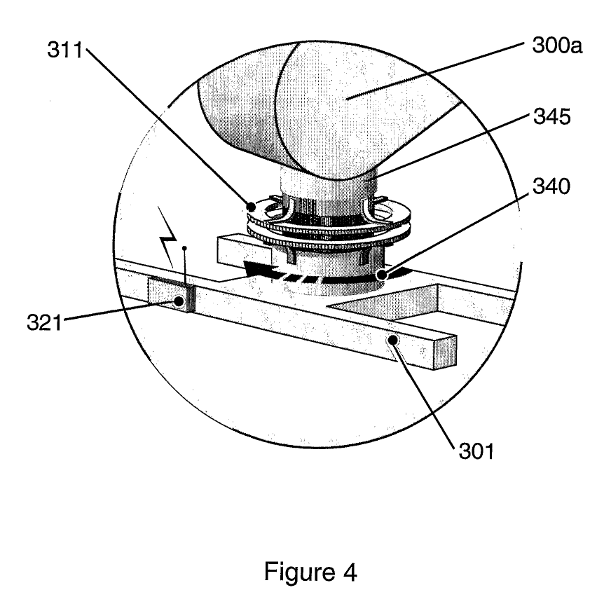

FIG. 3 shows an industrial robot 300 with a tool 301 according to an embodiment of the invention under control of a robot controller 325. Robot controller 325 is arranged with a wireless transmitter/receiver 320. In the expanded detail of FIG. 3 it is shown that tool 301 has a wireless receiver/transmitter 321 arranged on it. Also shown in more detail in FIG. 3 (and again in FIG. 4) are two inductive power supply rings 311, or coils, similar to coils 11 of FIG. 1, one mounted on the robot arm/wrist 345 at the tool holder and the other mounted on the tool 301. The tool 301 is free to rotate in a direction indicated by arrow 340. Preferably the power supply delivered to actuators and/or sensors at the tool side is 24 volts.

FIG. 4 is a close-up of the tool arrangement, from which it may be understood that tool 301 is fully rotatable on the end of robot arm or wrist 345 in the direction of arrow 340 without interference from any control cabling. In this case, as the power supply is contactless as well, there are no electrical power supply cables to be threaded and routed out to the tool. This also means that changing the tool 301 is greatly simplified, with no cables to be plugged/unplugged or get in the way, simplifying the automation of tool changes greatly. The robot arm or wrist 345 may optionally include a tool changer, and may thereby comprise a locking device in the robot wrist, in which case no separate locking device as such is required on the tool.

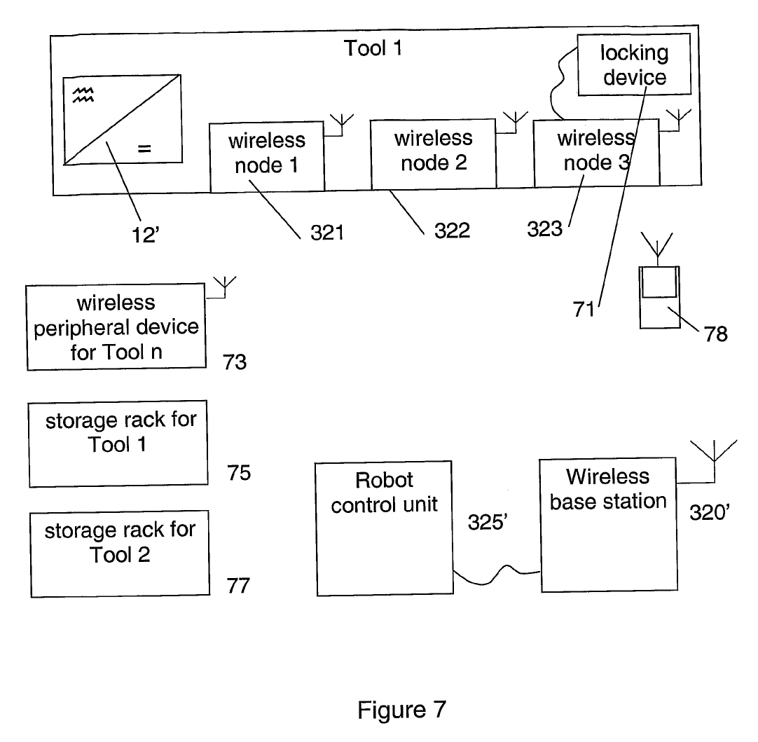

FIG. 7 shows a system for controlling an industrial robot equipped with a tool. The figure shows schematically a tool, Tool 1, 301′ and a robot control unit 325′ connected to a wireless communication unit 320′ (see also the similar reference numbers for the same items in FIG. 3). Tool 1 includes a locking device 71 which may be wirelessly controlled (not shown) and alternatively may be not wirelessly controlled, wireless nodes 321-323, and a contactless power supply 12 (see also FIG. 1).

The figure also shows schematically two exemplary storage racks 75, for Tool 1, 301 and 77 for a second tool, Tool 2. Also included in FIG. 7 are a peripheral device 73 or jig or tool or turntable etc which may also be wirelessly controlled, and a portable computing device 78 within wireless range of the system. Thus in a production cell with the system of FIG. 7 and at least one robot equipped with a tool according to the present invention a system the invention may be advantageously practised. The tool 301 is used to carry out operations according to a movement control program comprised in the robot control unit 325′, 325. Instructions are sent using wireless base station 320, 320′ to the one or more wireless nodes 321-323 on the tool. One or more actuators (not shown) may be powered by the contactless power supply 12 (see also FIG. 1 for more details for a contactless power supply, described above). Data from and/or to sensors and/or actuators may be sent from/to the tool (via the wireless node which the sensor/actuator is connected to, e.g. 321) to the robot control unit 325 via the wireless base station 320, which may or may not be located inside the robot control unit. Other control units (not shown) may also be present in the production cell, for example one or more simple controllers or PLCs, for control over certain functions. A PLC may optionally be fitted to the robot control unit (325) or directly to the Wireless base station (320) to carry out distributed control over one or more functions of the tool.

Storage racks 75, 77 for tools may be wirelessly controlled as indicated or controlled and/or powered by other means. A technician may use a portable computing device 78, a PDA, telephone or similar, to examine, monitor and/or interact with the control system in other ways via a wireless connection.

In the preferred embodiment, a control program for making the robot or robots perform operations on a work object is designed so that it is divided up into a number of tasks. In more detail, the movement control program includes a number of movements that the robot shall carry out. One or more movements are then normally handled as one or more tasks. In a painting program, for example, each separate paint stroke (movement) may be treated as a separate task. With spot welding, movement to and performance of each spot weld may be a task, whereas when a robot application is fitting a trunk lid to an automobile each movement such as grip, lift, place, release may each be one task, if that is an appropriate way to divide up the movements in the program. In certain cases, for example, when making a long movement using a robot controlled laser or high power water jet to cut through a steel plate, a single movement that carries on for a relatively long time or distance may be divided up into more than one task.

Having programmed a Movement Program for a robot as including a number of movements comprising tasks, and verified the program with a run through, the next principle is that in the event that a stoppage occurs, the robot completes the present task but may not begin the subsequent task. The robot simply waits until an instruction is received to continue before proceeding with the next task.

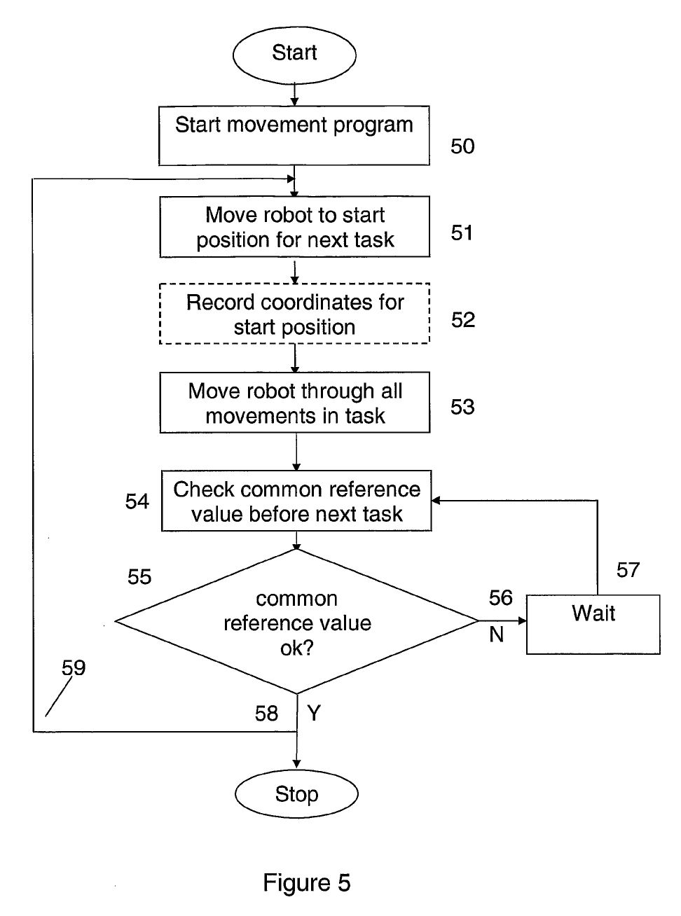

FIG. 5 shows steps of a method for controlling a robot with a tool according to the preferred embodiment of the invention. The program starts at step 50 and the robot moves to the first task or the next task 51. When the robot is in a teaching (programming) mode or a verify (program) mode, step 52 is included to capture, preferably automatically, a common reference value such as a time or coordinate position at which the next task starts. When operating normally, step 52 is by-passed. The robot moves through all the movements of the present task 53. Before starting the next task, the robot checks 54 a common reference value to see if the common reference value in use, a time at which a work object is in place or a position of the work object in order to start. If the common reference value is within limits a Yes 58 results in the robot starting the next task. If the common reference value is not acceptable, N, 56, the robot waits 57 until such time as the common reference value is found to be within limits. In this way a temporary stoppage in a production line or cell does not result in robots stopping in an uncoordinated way, so that each robot must be manually jogged to some position before a re-start may be carried out. Instead each robot simply resumes at the start of the next task following the end of the task at which they stopped.

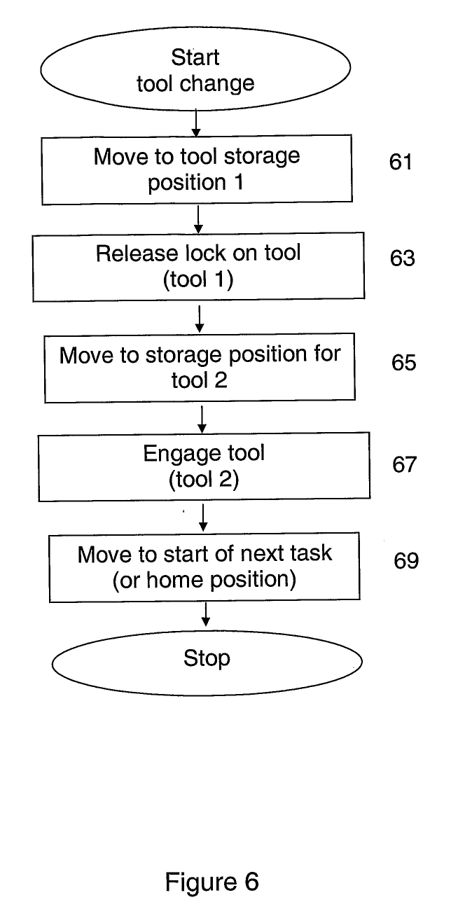

FIG. 6 shows steps of a method according to the invention for changing a tool. This method may be carried out automatically, by the robot so as to say. The figure shows that the robot in a first step 61 moves the tool presently mounted on the robot to a storage position. At the correct position, the robot actuates 63 a release mechanism to release the present tool from the tool holder on the robot arm. The robot then moves the arm 65 to a storage position where the next tool required is stored. When the robot arm is correctly positioned ready to engage the next tool, the robot actuates 67 a device that the tool is mechanically locked to the tool holder on the robot arm. According to a preferred embodiment, the robot moves to the next task 69 in the control program. In this way, the tool may be automatically changed in the middle of a control program so that a robot may change to a new tool, if necessary, whilst working a given work object and thus perform a slightly different operation on the same work object.

In a further embodiment another or more complex or advanced communication pattern may be generated and passed over the power supply system if so desired, which may be detected by comparison, by a statistical method, or by a pattern recognition method.

In another preferred embodiment the receiver side in the contactless power system is arranged with a second rectifier on the high frequency power signal and a small filtering capacitor and a load resistance to detect communication signals. Other variations of the principles of the invention as disclosed here may be practised. One or both of wireless transmitter 20 and wireless receiver 21 may for example be wireless transceivers (transmitter-receivers). Wireless communications may be carried out using any suitable protocol. Short range radio communication is the preferred technology, using a protocol compatible with, standards issued by the Bluetooth Special Interest Group (SIG), any variation of IEEE-802.11, WiFi, Ultra Wide Band (UWB), ZigBee or IEEE-802.15.4, IEEE-802.13 or equivalent or similar. A standard compatible with WAPI (WLAN Authentication and Privacy Infrastructure, GB15629.11-2003 or later) may advantageously be used in situations where encryption of the wireless signal is necessary.

Generally a radio technology working at high frequencies usually greater than 400 MHz, for example in the ISM band or higher, with significant interference suppression means by spread spectrum technology is the preferred type of wireless communication. For example a broad spectrum wireless protocol in which each or any data packet may be re-sent at other frequencies of a broad spectrum at around 7 times per millisecond, for example, may be used, such as in a protocol developed by ABB called Wireless interface for sensors and actuators (Wisa). Wireless communication may alternatively be carried out using Infra Red (IR) means and protocols such as IrDA, IrCOM or similar. Wireless communication may also be carried out using sound or ultrasound transducers.

The robot and/or automation application with a tool according to the present invention may applied to operations such automobile assembly and to manufacturing processes used in automobile manufacturing. The robot or automation application may be used to carry out any of: welding, soldering, electrical soldering, riveting, fettling, painting, spray painting, electrostatic powder spraying, gluing, operations performed in relation to metal processing processes such as continuous casting, casting, diecasting and production methods for other materials such as plastic injection moulding, compression and/or reaction moulding or extrusion. The robot application may carry out other operations, including such as folding plate, bending plate and/or hemming plate. The robot application may comprise a plurality of tools, both specialised tools for welding, painting etc as well as other more general devices, grippers, claws, manipulators and so on that carry out manipulation-type tasks such as holding, placing, pick and place, and even packing of components or subcomponents in a container.

A best use of the power supply for a robot application is in the application of assembling parts on automobiles, such as fitting hoods, trunk lids, windshield glass, back window glass and the like in an automobile plant, and preferably also in conjunction with a connection to an industrial control system such as ABBs Industrial IT. A contactless power supply enabled without duplicated cabling on the tool side is very advantageous. It means that the actuators in a manipulating or gripping and/or placing operation may be more efficiently and more economically provided with a safe and separate power supply without loading the robot arm with unnecessary cabling and control components. Wear on cabling between robot wrist and the tool is eliminated. Automatic tool changes in particular are also facilitated by this invention, enabling automatic tool changes without interrupting production. Thus differently shaped parts intended for different versions of the same type of automobile, eg different back window glass for estate car vs passenger car, may be accommodated automatically in the same production cell of a production line or assembly area by means of automatic tool changes carried out by one or more of the robots. Similarly, different welding tools may be exchanged by the robot so as to carry out welding tasks in different parts of a car body or with different welding rod/welding tip combinations.

Also included in FIG. 7 are a peripheral device 73 or jig or tool or turntable etc which may also be wirelessly controlled. The wirelessly controlled peripheral device 73 may be a turntable, jig or tool or a tool changer. A PLC may optionally be fitted to a wirelessly controlled peripheral device 73 to carry out distributed control over one or more functions of the peripheral device. The peripheral device may be a turntable equipped with a contactless power supply of the same type as the contactless power supply 12, 12′ of the robot tool 1, 301 described above. The wirelessly controlled peripheral device may also be a rotatable or moveable device, such as a turntable, or moveable tool changer, transfer device, jig or tool.

One or more microprocessors (or processors or computers) comprise a central processing unit CPU performing the steps of the methods according to one or more aspects of the invention. This is performed with the aid of one or more computer programs, which are stored at least in part in memory accessible by the one or more processors. The or each processor may be located in, or arranged connected to, power supply 12 on the tool side, and/or, at least in part, in the robot control system 25, 325. It is to be understood that the computer programs for carrying out methods according to the invention may also be run on one or more general purpose industrial microprocessors or computers instead of one or more specially adapted computers or processors.

The computer program comprises computer program code elements or software code portions that make the computer or processor perform the methods using equations, algorithms, data, stored values, calculations and statistical or pattern recognition methods previously described, for example in relation to FIGS. 1, 5, 6, 7. A part of the program may be stored in a processor as above, but also in a ROM, RAM, PROM, EPROM or EEPROM chip or similar memory means. The program in part or in whole may also be stored locally (or centrally) on, or in, other suitable computer readable medium such as a magnetic disk, CD-ROM or DVD disk, hard disk, magneto-optical memory storage means, in volatile memory, in flash memory, as firmware, or stored on a data server. Other known and suitable media, including removable memory media such as Sony memory stick™ and other removable flash memories, hard drives etc. may also be used. The program may also in part be supplied from a data network, including a public network such as the Internet, via a temporary hard-wire data connection and/or via the wireless communication unit 21 arranged on the tool side. Parts of the above computer programs executing in a component on the tool side may be updated and/or data or control instructions may be also provided by a temporary hard wire network connection and/or by the wireless receiver or transceiver 21. This is especially beneficial for wireless updating of the programs in the tool side components so that updating, configuring can be carried out without requiring an operator to physically enter the robot production cell or automation application area.

The computer programs described may also be arranged in part as a distributed application capable of running on several different computers or computer systems at more or less the same time.

Methods of the invention may also be practised, for example during a configuration phase, or following a stoppage, or during normal operations by means of a Graphical User Interface (GUI), a graphical or textual display on an operator workstation, running on a user's logged-in computer, portable computer, combined mobile phone and computing device, or PDA etc 78, connected direct to the robot control system, or connected via a main or local control server, or other control unit even such as a simple controller or PLC, or via a control system computer/workstation.

It should be noted that while the above describes exemplifying embodiments of the invention, there are several variations and modifications which may be made to the disclosed solution without departing from the scope of the present invention as defined in the appended claims.

1. A tool for an industrial robot comprising at least one actuator, said industrial robot having at least one arm with a tool holder arranged on the arm, characterized in that
the tool (1, 301) comprises at least one wireless communication member (21, 321) and a contactless power supply (12, 12′) for the at least one actuator (4).

2. A tool according to claim 1, characterised in that the power supply (10, 12) includes a power supply member (12) comprising a logic member (16) arranged to provide two or more power supplies (31, 32) of which at least one power supply (32) is separately controllable.

3. A tool according to claim 1, characterised by comprising at least one sensor.

4. A tool according to claim 3, characterised in that the sensor receives power from the contactless power supply.

5. A tool according to claim 1, characterised in that the power supply is based on electromagnetic induction devices.

6. A tool according to claim 5, characterised by comprising one or more coils (11, 311) for induction of a time-varying voltage arranged connected relative a power supply (12).

7. A tool according to claim 1, characterised in that the wireless communication member a radio technology working in a high frequency band from 400 MHz and higher with significant interference suppression means by spread spectrum technology.

8. A tool according to claim 7, characterised in that the radio technology works in frequencies compatible with the ISM band or any other suitable radio band.

9. A tool according to claim 1, characterised in that the or each wireless communication member (21-23, 321-323) of the tool (1, 301) is arranged with means for wireless transmission of data to a control unit of the robot from an actuator and/or sensor arranged with the tool.

10. A tool according to claim 9, characterised in that the or each wireless communication member (321-323) is arranged with means for receiving instructions and/or data for an actuator arranged with the tool from a control unit (325, 325′) of the robot.

11. A tool according to claim 1, characterised in that the power supply has means (16) for detecting a signal comprised in the power of the power supply.

12. A tool according to claim 11, characterised in that the signal is overlaid on a time varying voltage.

13. A tool according to claim 1, characterised in that the tool comprises a means (61) for locking the tool to the tool holder of the robot.

14. A method to control an industrial robot with a control unit (25, 325) and with a tool (1, 301) comprising at least one actuator, said industrial robot having at least one robot arm with a tool holder arranged on the arm, characterised by:
providing a contactless power supply (12, 12′) to said at least one actuator of said tool (1, 301), and
transmitting and/or receiving control signals to at least one wireless node (21, 321, 321′-323′) arranged on said tool.

15. A method according to claim 14, characterised by the control unit (25, 325, 325′) providing control signals to cause the actions of:
moving the robot arm and arranging the tool in a storage position (66) for present said tool,
releasing a locking member (61) of the tool,
moving the robot arm to a second tool arranged at a second storage position (67),
actuating the locking member.

16. A method according to claim 15, characterised by moving to the next task in the control program of the robot.

17. A method according to claim 16, characterised by stopping and waiting before moving to the next task in the control program of the robot in the event that a common reference value is not acceptable.

18. A method according to claim 15, characterised by moving to a home position of the robot.

19. A method according to claim 14, characterised by providing control signals from the control unit (325, 325′) dependent on a signal from a wirelessly controlled peripheral device (73) and/or a storage rack (75, 77).

20. A graphical user interface for controlling an industrial robot with a tool (301) comprising at least one actuator, said industrial robot having at least one robot arm with a tool holder arranged on the arm, characterised by a display of a computing device or portable computing device (78) with means for monitoring and/or interacting with a robot tool (1, 301) comprising at least one wireless communication member (21, 321) and a contactless power supply (12).

21. A computer program comprising computer code means and/or software code portions for making a computer or processor perform a method according to any of claims 14-19.

22. A computer program product comprising the computer program according to claim 21 comprised in one or more computer readable media.

23. A control system for an industrial robot equipped with a tool (301) comprising at least one actuator, said industrial robot having at least one robot arm with a tool holder arranged on the arm, and a robot control unit (325, 325′), characterised in that said at least one tool (301) is arranged with a contactless power supply means (12), and a wireless communication member (321) for communication with a control unit (320).

24. A control system according to claim 23, characterised in that the industrial robot is arranged with a wireless power supply means (311) on the robot arm or the tool holder (345).

25. A control system according to claim 24, characterised in that the tool of the industrial robot is arranged with at least one contactlessly powered actuator.

26. A control system according to claim 23, characterised in that the tool of the industrial robot is arranged with at least one sensor arranged for wireless communication with a control unit.

27. A control system according to any of claims claim 23-26, characterised in that the wireless communication to the robot tool may be carried out using a wireless protocol compatible with any standard issued by the Bluetooth Special Interest Group (SIG), any variation of IEEE-802.11, WiFi, Ultra Wide Band (UWB), ZigBee or IEEE-802.15.4, IEEE-802.13, or equivalent or similar; WAPI according to GB15629.11-2003 or later.

28. A control system according to any of claims claim 23-27, characterised by in that the wireless communication to the robot tool is carried out using a broad spectrum wireless protocol in a high frequency band, the ISM band or a band up to 4 GHz or more with significant interference suppression means by spread spectrum technology.

29. A control system according to claim 28, characterised in that a broad spectrum wireless protocol is used for wireless communications in which each or any data packet may be re-sent at other frequencies of the broad spectrum a plurality of times.

30. A control system according any previous claim 23-29, characterised by comprising a wirelessly controlled peripheral device (73).

31. A control system according claim 30, characterised in that the wirelessly controlled peripheral device (73) is equipped with a contactless power supply.

32. A control system according claim 30, characterised in that the wireless peripheral device (73) comprises any device from the list of: turntable, tool changer, jig, tool.

33. A control system according claim 30, characterised in that the wireless peripheral device (73) comprises any rotating or moveable or transfer device from the list of: turntable, tool changer, jig, tool.

34. A control system according claim 30, characterised in that at least one of the one or more tool storage members (75, 77) is wirelessly controlled.

34. A control system according any previous claim 23-33, characterised in that a wireless peripheral device (73) and/or a storage member (75, 77) is controlled at least in part by a programmable logic controller.

35. A control system according any previous claim 23-34, characterised by one or more computer programs comprising computer code means and/or software code portions for making a computer or processor perform a method according to any of claims 14-19.

36. Use of a tool according to any of claims 1-11 for operations with a robot or automation application (1) in an industrial or commercial installation or place of work.

37. Use of a system according to any of claims 23-35 to control operations with a robot or automation application (1) in an industrial or commercial installation to carry an operation comprising any from the list of: fitting parts to automobiles, painting, welding, soldering, riveting, gluing, folding plate, bending plate, hemming plate, fettling, cutting, laser cutting, water-jet cutting, gripping an object, manipulating an object, stacking, pick and place, palletising, depalletising.
